(19) United States
(12) Patent Application Publication
(10) Pub. No.: US 2004/0020831 A1
(43) Pub. Date: Feb. 5, 2004

(54) Method and device for determining a temperature distribution of bulk material

(76) Inventors: Peter Meinlschmidt, Braunschweig (DE); Burkhard Plinke, Braunschweig (DE)

Correspondence Address: WHITHAM, CURTIS & CHRISTOFFERSON, P.C., 11491 SUNSET HILLS ROAD, SUITE 340, RESTON, VA, 20190, US

(21) Appl. No.: 10/381,038

(22) PCT Filed: Aug. 30, 2001
(86) PCT No.: PCT/DE01/03336

(30) Foreign Application Priority Data
Sep. 23, 2000 (DE) 100 47 269.9

(51) Int. Cl. B07C 5/00

(52) U.S. Cl. 209/576; 209/577

(57) ABSTRACT

According to the invention, the bulk material is dropped down a drop section (5) for the purpose of separating the material, in order determine the temperature distribution of the bulk material very accurately and as completely as possible. Said drop section can be configured e.g. at the end of the conveyor belt (1). A thermographic measuring device (10, 11) is used to carry out spatially resolved measurement of the bulk material in a measuring area (15) of the drop section (5). The temperature distribution of the bulk material can then be determined from the measuring values (m). Local temperature increases in particular can be determined during this process, by comparison with a maximum allowable limit temperature, as can an inhomogeneity in the temperature distribution.

The invention relates to a method and an apparatus for determining a temperature distribution of bulk material.

During the working and processing of bulk materials, in particular during the drying of bulk materials, agglomerations of particles often arise which maintain very high temperatures in their interior in some instances for a long time. If said agglomerations come into an oxygen-rich environment, fires can arise with, in some instances, considerable consequential costs. Therefore, it is endeavored to identify these hot agglomerations or hot particles early and as far as possible in the course of the working process in order to make corrective intervention in the production process and remove or eliminate them.

Depending on the type and extent of the material to be examined, at the present time various methods are used to identify risks of fire due to local overheating:

Point measurement systems, such as e.g. thermopile sensors, indicate when an open spark is identified. In this case, for safety reasons, a plurality of these sensors can be installed one after the other in order to identify as many sparks as possible or to check possible elimination actions with regard to their efficacy.

Furthermore, in some instances fast, areal measurement systems, such as e.g. CCD cameras, are used which carry out an optical measurement of the bulk material in the visible light region, but can identify the bright sparks only in a darkened measurement volume.

Furthermore, incendiary particles can be determined with the aid of smoke or gas detectors, a targeted localization and removal of said particles not being possible by this means.

What is disadvantageous about such methods and apparatuses is, in particular, that particles or agglomerations of particles at risk of fire cannot be identified in a targeted manner. Furthermore, the known measurement methods are disturbed by disturbing influences of the environment, e.g. extraneous light in the case of using CCD cameras. What is also problematic, in particular, is the identification of particles or agglomerations of particles which are concealed by other particles on the conveyor belt and thus cannot be identified at all, or can only be identified with difficulty, from the outside.

The invention is based on the object of providing improvements with respect to the prior art, and in particular of providing a method and an apparatus for determining a temperature distribution of bulk material which ensure an accurate determination of the temperature distribution of the bulk material, and complete detection of the entire bulk material. This is intended to be ensured advantageously with a relatively low outlay and with no interruption to current processes.

This object is achieved firstly by means of a method for determining a temperature distribution of bulk material, in which the bulk material falls down a drop section for the purpose of separating the bulk material, a spatially resolved thermographic measurement of the bulk material is carried out in a measurement region of the drop section and measured values are output, and a temperature distribution of the bulk material in the drop section is determined from the measured values.

Furthermore, this object is achieved by means of an apparatus for determining a temperature distribution of bulk material, having a drop section for the purpose of separating the bulk material, a thermographic measuring device for the spatially resolved measurement of the bulk material in a measurement region of the drop section and outputting of measured values, and an evaluation unit for receiving the measured values and determining the temperature distribution.

The invention is based on the concept of separating the. bulk material and examining the separated bulk material thermographically. The separation is effected according to the invention by means of a drop section. For this purpose, the bulk material may be transported e.g. on a conveyor belt and dropped from an end of a conveyor belt. Furthermore, the bulk material may also e.g. slide down an inclined plane and subsequently fall or be tipped out of a container, so that the drop section may be arranged at the end of the sliding plane, at the end of the container or at another suitable location.

The bulk material is measured by cameras directed at a measurement region of the drop section. If the bulk material is supplied in a manner distributed over the width of the conveyor belt or the width of a sliding plane and further separation occurs due to the acceleration of the bulk material on account of the gravitation in the drop section, a sufficiently good detection of the individual particles or agglomerations of particles can be achieved with the cameras. Depending on the quantity conveyed, it is possible to use on the one hand a sufficiently wide bulk material stream and on the other hand a sufficiently large drop section.

By using at least two cameras arranged at opposite sides of the drop section, the accuracy and reliability of the measurement method are increased. The bulk material quantity conveyed can also be increased in turn by this means.

According to the invention, it is possible to use either area-type cameras which in each case detect and spatially resolve an areal region of the measurement section. Temperature increases of the individual measurement points can be detected depending on the spatial resolution. With the use of an area-type camera, the entire bulk material stream can be detected by means of a clocked recording method, the image recording frequency depending on the height of the measurement region and the falling speed of the bulk material.

Furthermore, it is also possible to use line-type cameras which in each case detect linear regions of the drop section. With the use of a line-type camera, a continuous image acquisition or image acquisition with a sufficiently high frequency is effected, so that the entire bulk material stream which falls down the drop section can be detected by means of the individual measurements of the linear measurement regions.

According to the invention, the separation of the bulk material in the respective measurement region is set by the width of the conveyor belt or width of the sliding plane to which bulk material is applied, the transporting speed on the conveyor belt or sliding speed on the sliding plane, by the falling speed in the drop section (which is set by the drop height) and also the distance between the respective camera and the drop section. These variables can be varied in a desired manner according to the invention in order to ensure a complete measurement with sufficient separation.

According to the invention, the temperature values of the individual measurement points of the measurement region may firstly be compared with a predetermined maximum limit temperature, a local overheating being ascertained in the event of the limit temperature being exceeded. In this case, the relevant region of the material stream can advantageously be removed, for example expelled or ejected; furthermore, extinguishing is possible, e.g. by adding water or cooling gas to the relevant region. The hot particles or agglomerations of particles are advantageously removed or extinguished on a receiving conveyor belt arranged below the drop section, since this does not influence the measurement of the material stream in the drop section. Such a method can be used in particular during the processing of wood materials, e.g. shavings or wood fibers.

Furthermore, it is possible according to the invention to determine inhomogeneities in the temperature distribution of the bulk material. For this purpose, a relative temperature distribution of the bulk material in the material stream on the drop section is determined by comparing the temperature values of the measurement points of a measurement region with one another. If inhomogeneities are identified, individual regions can likewise be removed or cooled; furthermore, it is also possible to carry out a subsequent additional intermixing of the bulk material in order to bring about a temperature equalization. Such a method for determining the inhomogeneity of the bulk material can be used e.g. during the processing of tobacco, since inhomogeneities in the temperature distribution lead to an impairment of the quality. Furthermore, such a method can also be used e.g. in the treatment of foodstuffs.

The measured values determined by the camera or cameras are subsequently output to an evaluation unit which performs the comparison with the maximum permissible limit temperature and the determination of possible instances of immobility. The measured values of the bulk material stream can furthermore be represented on display units, the images of each camera advantageously being reproduced on a separate display unit. In this case, the temperatures of the individual measurement points can be reproduced by different colors in a manner known per se.

According to the invention, the prearranged processing process can be influenced both during the checking for local overheating and during the checking of the relative temperature distribution. In this case, a processing temperature in a prearranged processing process can be lowered, in particular, in the event of local overheating being ascertained or relatively large inhomogeneities being ascertained.

The invention is explained in more detail below using a few embodiments with reference to the accompanying drawings, in which:

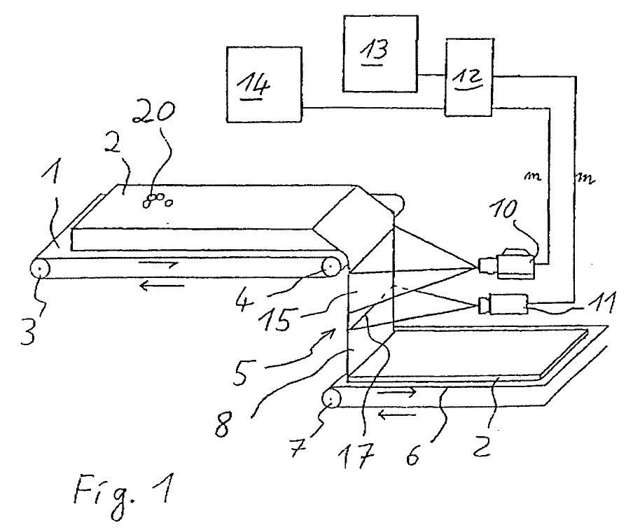

FIG. 1 shows the construction of an apparatus according to the invention in accordance with a first embodiment of the invention;

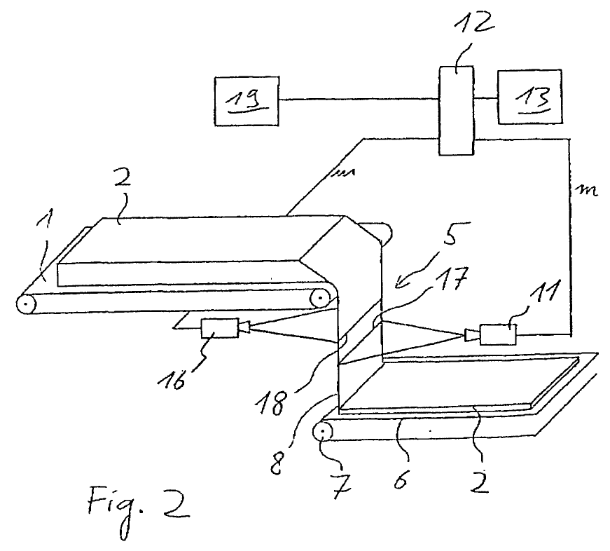

FIG. 2 shows a further embodiment of the invention.

In accordance with FIG. 1, bulk material 2 is conveyed on a conveyor belt 1, which is moved between two deflection rollers 3 and 4. The bulk material 2 has individual particles 20 which are agglomerated in some instances—e.g. on account of their moisture. The bulk material 2 may be accommodated by lateral boundaries of the conveyor belt which are not shown in the figures.

At one end of the conveyor belt—at the deflection roller 4 in FIG. 1—the bulk material 2 subsequently falls down a drop section 5 and forms a bulk material stream 8. The bulk material stream 8 runs essentially vertically downwards; in the case where relatively large transporting speeds are used on the conveyor belt 1, the bulk material stream 8 may initially still have a horizontal speed component in an upper region of the drop section 5; however, an essentially vertical course of the bulk material stream 8 can be achieved in a region of the drop section 5 arranged further down and in particular in the case where relatively low conveying speeds are used.

The drop section 5 may be delimited toward the bottom e.g. by a collecting container or a collecting location. It is advantageous that, in accordance with FIG. 1, a receiving conveyor belt 6 is provided which is guided e.g. via deflection rollers 7 and transports the received bulk material 2 away again.

According to the invention, provision is made of at least one infrared camera directed at a measurement region of the bulk material stream 8 in the drop section 5. FIG. 1 shows, in this respect, firstly an area-type camera 10 which detects an areal measurement region 15 of the bulk material stream 8 in the drop section 5. Such an area-type camera can detect the entire bulk material stream 8 falling from the first conveyor belt 1, if it operates with a sufficiently large image recording frequency. Said image recording frequency is acquired by the height of the measurement region 15, which is in turn determined by the recording angle of the area-type camera 10 and the distance between the camera 10 and the drop section 5. Furthermore, the image recording frequency is determined by the falling speed of the material stream 8 in the drop section 5.

According to the invention, it is possible to use, in addition or as an alternative, a line-type camera 11, which is likewise shown in FIG. 1 and detects a linear measurement region 17 of the material stream in accordance with FIGS. 1, 2. The linear measurement region advantageously runs essentially in the horizontal direction, i.e. perpendicular to the falling direction of the bulk material. A continuous or quasi-continuous measurement of the bulk material stream 8 is ensured through a sufficiently high image recording frequency.

Measured values m of the respective camera 10, 11 are output to an evaluation unit 12, which in each case assigns a temperature value to the respective measurement points. The temperature values of the individual measurement points can subsequently be compared with a predetermined maximum limit temperature in order to ascertain a local excessive temperature increase. In this case, the respective process can be stopped; in an advantageous manner, the bulk material regions in which an excessively increased temperature has been ascertained are subsequently removed on the receiving conveyor belt 6, e.g. expelled, ejected or else cooled or extinguished. For this purpose, corresponding control signals are output to the device used for the removal or extinguishing.

Furthermore, in the evaluation unit 12, a comparison of the temperature values of the individual measurement points can be performed in order to determine inhomogeneities in the temperature distribution. In this case, e.g. bulk material regions having a relatively high temperature can furthermore be removed or extinguished; furthermore, a subsequent intermixing of the bulk material can be carried out in order to adapt the temperature.

The temperature distribution of the material steam 8 can be reproduced in each case on display units 13 and 14, e.g. monitors. In this case, individual temperature values can be reproduced e.g. by different colors.

An area-type camera 10 and a line-type camera 11 are shown by way of example in FIG. 1. According to the invention, these cameras can be used alternatively or else in combination. In particular, cameras can be arranged in accordance with FIG. 2 at opposite sides of the bulk material stream 8 of the drop section 5, thereby enabling a better detection of the bulk material stream 8 in the drop section. The reliability or measurement accuracy is thus increased. Furthermore, the conveying rate of bulk material on the conveyer belt 1 can be increased since thicker bulk material streams 8 can be examined.

During the examination of the material stream 8 from both sides, it is possible, in accordance with FIG. 2, to use two line-type cameras 11, 16 which each detect linear measurement regions 17, 18. Furthermore, the use of two area-type cameras and also the use of one area-type camera and one line-type camera are also possible. The measured values m are once again initially output to an evaluation unit 12 which once again drives display units 13 and 19.

According to the invention it is advantageous that, in the event of local overheating or inhomogeneities in the temperature distribution being ascertained, it is also possible to effect controlling intervention in the prior process, e.g. a bulk material heating process.

1. A method for determining a temperature distribution of bulk material, in which
the bulk material (2) falls down a drop section (5) for the purpose of separating the bulk material,
a spatially resolved thermographic measurement of the bulk material (2) is carried out in a measurement region (15, 17, 18) of the drop section (5) and measured values (m) are output, and
a temperature distribution of the bulk material in the drop section (5) is determined from the measured values (m).

2. The method as claimed in claim 1, characterized in that the bulk material [lacuna] transported on a conveyor belt (1) and falls down the drop section at an end of the conveyor belt.

3. The method as claimed in claim 1 or 2, characterized in that at least one measurement of the bulk material (2) is carried out in each case from a front side and a rear side of the drop section (5).

4. The method as claimed in one of claims 1 to 3, characterized in that linear measurement regions (17, 18), preferably linear measurement regions perpendicular to a falling direction of the bulk material, are measured continuously.

5. The method as claimed in one of claims 1 to 3, characterized in that areal measurement regions (15) of the drop section (5) are measured.

6. The method as claimed in claim 5, characterized in that the areal measurement regions (15) are measured at time intervals.

7. The method as claimed in one of claims 1 to 6, characterized in that the measured temperature distribution of the bulk material (2) is used to determine whether the temperature values of individual bulk material regions, in particular individual particles (20) or agglomerations of particles, exceed a predetermined limit temperature.

8. The method as claimed in claim 7, characterized in that bulk material particles which exceed the limit temperature are ejected or expelled.

9. The method as claimed in one of claims 1 to 6, characterized in that a relative temperature distribution of the bulk material (2) in the measurement region (15, 17, 18) is determined, from which inhomogeneities in the temperature distribution are determined.

10. The method as claimed in one of claims 1 to 9, characterized in that a prearranged heating process of the bulk material (2) is controlled in a manner dependent on the temperature distribution determined.

11. An apparatus for determining a temperature distribution of bulk material, in particular for carrying out a method as claimed in one of claims 1 to 10, having
a drop section (5) for the purpose of separating the bulk material,
a thermographic measuring device (10, 11, 16) for the spatially resolved measurement of the bulk material in a measurement region (15, 17, 18) of the drop section and outputting of measured values (m), and
an evaluation unit for receiving the measured values (m) and determining the temperature distribution.

12. The apparatus as claimed in claim 11, characterized in that a conveyor belt (1) is provided for transporting the bulk material, and the drop section (5) is provided below an end of the conveyor belt (1).

13. The apparatus as claimed in claim 11 or 12, characterized in that the thermographic measuring device has at least one infrared camera (10, 11, 16).

14. The apparatus as claimed in claim 13, characterized in that at least one infrared camera (11) is provided at a front side and at least one infrared camera (16) is provided at a rear side of the drop section (5).

15. The apparatus as claimed in claim 13 or 14, characterized in that provision is made of at least one area-type camera (10) for recording an areal measurement region (15).

16. The apparatus as claimed in one of claims 13 to 15, characterized in that provision is made of at least one line-type camera (11, 16) for recording a linear measurement region (17, 18) running at least essentially perpendicularly to the falling direction.

17. The apparatus as claimed in one of claims 11 to 16, characterized in that provision is made of at least one display unit (13, 14, 19) for displaying the evaluated measured values.

18. The apparatus as claimed in one of claims 11 to 17, characterized in that the drop section (5) is delimited by a receiving conveyor belt (6) arranged below the conveyor belt.

19. The apparatus as claimed in one of claims 11 to 18, characterized in that provision is made of an ejecting or expelling device for ejecting or expelling bulk material particles, which receives control signals from the evaluation unit (12).

22. (New) The method as claimed in claim 1, characterized in that at least one measurement of the bulk material is carried out in each case from a front side and a rear side of the drop section.

23. (New) The method as claimed in claim 1, characterized in that linear measurement regions, preferably linear measurement regions perpendicular to a falling direction of the bulk material, are measured continuously.

24. (New) The method as claimed in claim 1, characterized in that areal measurement regions of the drop section are measured.

25. (New) The method as claimed in claim 5, characterized in that the areal measurement regions are measured at time intervals.

26. (New) The method as claimed in claim 1, characterized in that the locally overheated agglomerations determined are subsequently removed, cooled or extinguished.

27. (New) The method as claimed in claim 1, characterized in that the prearranged drying process for the bulk material is controlled in a manner dependent on the temperature distribution determined.

28. (New) The method as claimed in claim 1, characterized by the use of at least one area-type or line-type camera.
